(19) United States
(12) Patent Application Publication
(10) Pub. No.: US 2013/0199501 A1
(43) Pub. Date: Aug. 8, 2013

(54) FUEL INJECTOR WITH A VARIABLE ORIFICE

(71) Applicant: Deyang Hou, Sugar Land, TX (US)

(72) Inventor: Deyang Hou, Sugar Land, TX (US)

(73) Assignee: A FUEL INJECTOR WITH A VARIABLE ORIFICE, Sugar Land, TX (US)

(21) Appl. No.: 13/879,021

(22) PCT Filed: Oct. 11, 2011
(86) PCT No.: PCT/US11/55773

§ 371 Date: Apr. 11, 2013

Related U.S. Application Data
(60) Provisional application No. 61/391,724, filed on Oct. 11, 2010.

(51) Int. Cl. F02M 51/06

(52) U.S. Cl. CPC F02M 51/0603
USPC 123/472; 239/444

(57) ABSTRACT

A variable orifice fuel injector has both an inward opening needle valve and an outward opening needle valve and has means to inject fuel in different hollow conical spray patterns and conventional multiple jet spray patterns selectively and independently.

### CROSS REFERENCE TO RELATED APPLICATION

This application is based upon and claims the benefit of priority of U.S. Provisional Applications No. 61/391,724 filed on Oct. 11, 2010, the contents of which are incorporated herein by reference.

### TECHNICAL FIELDS

This invention related to a fuel injector and an internal combustion engine. More specifically, this invention disclosed a fuel injector with both inward and outward opening needle valves which can inject fuel in homogenous hollow conical spray or conventional multiple jet sprays selectively, and an engine using at least one such fuel injector, which can be a spark-ignition engine or a compression-ignition engine.

### BACKGROUND OF THE INVENTION

Description of the Related Art—The combustion process in a conventional direct injection Diesel engine is characterized by diffusion combustion with a fixed-spray-angle multi-hole fuel injector. Due to its intrinsic non-homogeneous characteristics of fuel-air mixture formation, it is often contradictory to simultaneously reduce soot and NOx formation in a conventional diesel engine. Over last two decades, significant progress has been made for Diesel engine combustion (U.S. Pat. Nos. 4,779,587, 6,230,683), but further reducing emissions from Diesel engines to comply upcoming emission legislations still remains a challenge. Progress has been made in recent years for advanced combustion modes, such as Homogeneous-Charge Compression-Ignition (HCCI) combustion and Premixed Charge Compression Ignition (PCCI). However, many issues remain to be solved to control the ignition timing, the duration of combustion, the rate of combustion for HCCI and PCCI engine for various load conditions. It seems more a viable solution to operate engine in mixed-mode combustion, or in HCCI mode or partially premixed mode at low to medium loads, and in conventional diffusion combustion mode at high loads for the near future. Or, we can use mixed-mode combustion even in same power cycle, such as proposed by the inventor in U.S. patent application Ser. No. 12/143,759.

A key challenge for mixed-mode combustion with conventional fix-angle multi-hole nozzle is surface wetting for early injections. There are many inventions (for example, PCT/EP2005/054057) could provide dual spray angle multiple jets spray patterns with smaller angle for early injections and larger spray angle for main injections. However, researchers find that, even with smaller jets, the conventional multiple jets spray still tend to wet the piston top and thus could cause emission issues such as hydrocarbon and mono-dioxide (SAE paper 2008-01-2400). This observation especially tends to be true for passenger car engines where cylinder diameter is small. In contrast, hollow conical sprays tend to give shorter spray pattern and much finer atomization which significantly cut the probability of combustion chamber surface wetting. On another side, most inventions disclosed so far are using inward opening for both inner and outer needle valves for producing multiple jets sprays. Such an arrangement produces significant space accommodation challenges and practical application issues to ensure the sealing of the two needle valves since the space available inside the nozzle tip is very limited. Thus, most dual needle fuel injector designs, even though they hold potentials to enable new combustion modes, can not be put into practical applications so far due to challenges in manufacture and durability concerns. Changing one needle motion of the dual needle structure to outward opening will reduce this space limitation on nozzle tip, and can leverage the space outside the inner space of nozzle tip for sealing surfaces. At the same time, the outward opening needle valve can produce more soft and homogeneous hollow conical sprays patterns which are more desirable for early injection premixed combustion.

### SUMMARY OF THE INVENTION

This invention disclosed a variable orifice fuel injector with coaxial inward and outward opening valves to inject fuel in hollow conical spray patterns and conventional multiple jet spray patterns selectively and independently. The variable orifice fuel injector can generate a hollow conical homogeneous fine atomization with smaller penetration which is suitable for early premixed combustion, it can also produce conventional multiple jets for conventional diffusion combustion. The fuel injector has the capability to quickly switch fuel spray pattern in a same engine power cycle.

The current invention uses one inward opening needle valve for multiple jet injection and one outward opening needle to provide hollow conical spray for early or late injections such as for after-treatment purpose. The seal surface for the outward opening needle valve is outside the nozzle body tip without competing with the inward opening valve for inner nozzle tip space. So it can reduce the confinement of the small inner space in nozzle tip to ensure better sealing for both the inward opening and outward opening needle valves. The currently disclosed fuel injector can generate a hollow conical fine uniform spray and multi jet spray patterns separately and selectively to meet the needs for variable spray penetration, variable spray angles for different engine operating conditions. The invention injector can provide an optimized spray pattern, including variable spray angles, to minimize wall-wetting and oil dilution related to early and post injections, thus cut emissions. It provides significant potential for a high efficiency clean engine with flexible fuel, including bio-fuels due to its flexible spray patterns.

### BRIEF DESCRIPTION OF THE DRAWINGS

FIG. 1 is a fragmentary sectional view of a first exemplary embodiment of an injector of the invention with only key components marked;

FIG. 2 is a fragmentary sectional view of a first exemplary embodiment of an injector of the invention with key components, key fuel passages, key surfaces, and key pressure control chambers marked.

FIG. 3 is an illustration of the operation state of injecting hollow conical spray by the embodiment of the fuel injector illustrated in FIG. 1;

FIG. 4 is an illustration of the operation state of injecting conventional multiple jet sprays by the embodiment of the fuel injector illustrated in FIG. 1;

FIG. 5 is an illustration of the injection spray patterns along with injection timings for an internal combustion engine using the fuel injector as in FIG. 1;

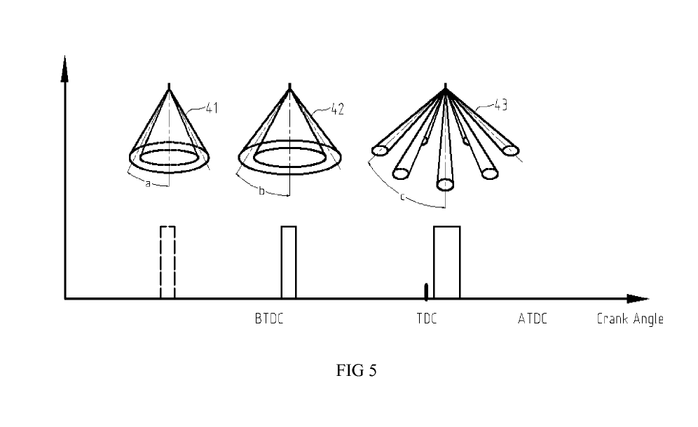

In all the figures,

1—inner outward opening needle valve; 101—inner needle valve head with an arrow-head shape, 131′—hollow conical spray fuel outlet (opened only when the inner needle valve is displaced from its seating position), 131—the sealing surface formed by pressing needle 1 into seating position on nozzle body 3, 102—seal surface of inner needle valve, 103—a narrow surface of 1, 104—top surface of arrow shape needle head, 161′—optional screw;
2—outer inward opening needle valve; 201—sealing surface of 2, 202—fuel passage to guide fuel to hollow conical outlet, 203—needle guide of 2, 204—thrusting surface of 2, 205—large end of 2, 206—thrusting surface, 231—contact sealing surface between needle 2 and nozzle body 3 when needle valve 2 is at seating position, 231′—fuel passage under needle seat of 2 when it is lifted, 232—fuel passage through 203, 233—fuel passage, 261—contact surface between 2&6 when needle guide 6 is pushed outward, 121—fuel passage, 122—sliding surface between 1 and 2;
3—nozzle body; 301—seal surface of 3 for outward needle valve 1; 302—fuel outlets for multiple jets; 303—high pressure fuel passage leading fuel to pressure chamber 234, 304—high pressure fuel passage to supply fuel to top of 2, 305—fuel passage leading fuel from pressure control chamber 261′ to fuel sink 15, 306—low pressure fuel passage in 8; 381—pressure chamber on top of 3, 382—contact surface between 3 and 8;
4—injector body cap; 341—contact surface between 3 and 4;
5—spring which urges needle valves 1 and 2 into seating positions;
6—needle guide which is tightly couple with needle valve 1 and can slide inside 3, 601—bottom surface of 6, 681—contact surface between 6 and 8, 161—tight fitting surface between 1 and 6;
7—needle valve clip which provides safety for fixing needle valve 1 to 6;
8—valve block which holds valves and fuel passages, 801—low pressure fuel passage to valve 9, 802—low pressure passage to valve 10, 803—high pressure passage;
9—low pressure control valve, which can be a single control valve or a control valve having a throttling valve before it connecting to 801;
10—low pressure control valve, which can be a single valve or a control valve having a throttling valve below it connecting to 802; 10′—optional throttling valve 11—high pressure control valve;
Valves 10 and 11 can be operated with a single actuator such that when 11 is opened 10 is closed, and vice versa;
12—high pressure fuel reservoir;
13—high pressure fuel reservoir;
12 and 13 can be one such as common rail;
14—optional valve between 12 and 13;
15—low pressure fuel sink;
20—hollow conical spray; a1—half hollow conical spray angle;
21—multiple jet spray; a2—half multiple jet spray angle;
261′—pressure control chamber for needle valve 2;
681′—pressure control chamber for needle valve 1;
234—pressure chamber for providing thrusting force for needle valve 2.

### DETAILED DESCRIPTION OF THE PREFERRED EMBODIMENTS

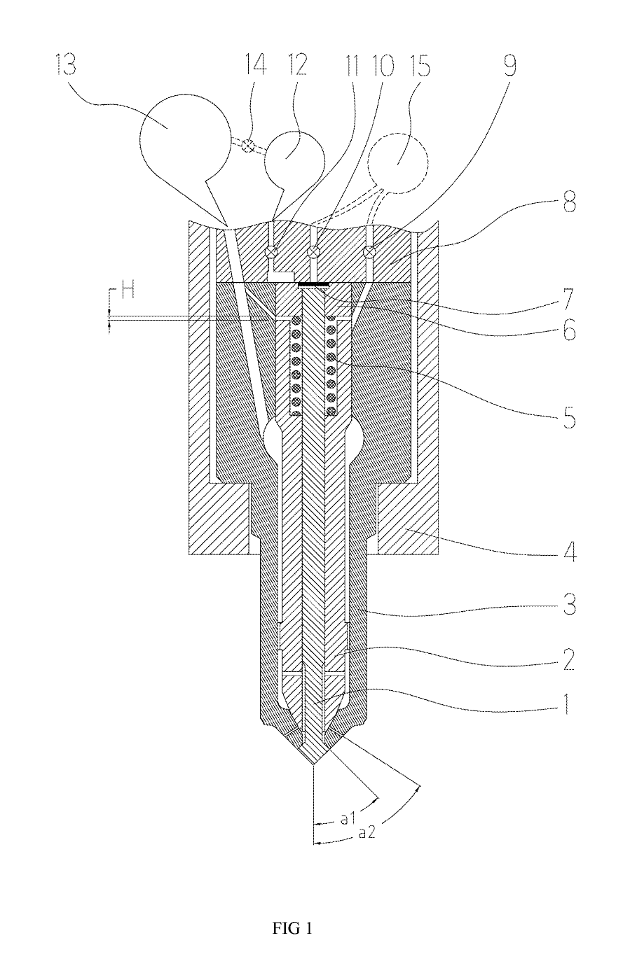

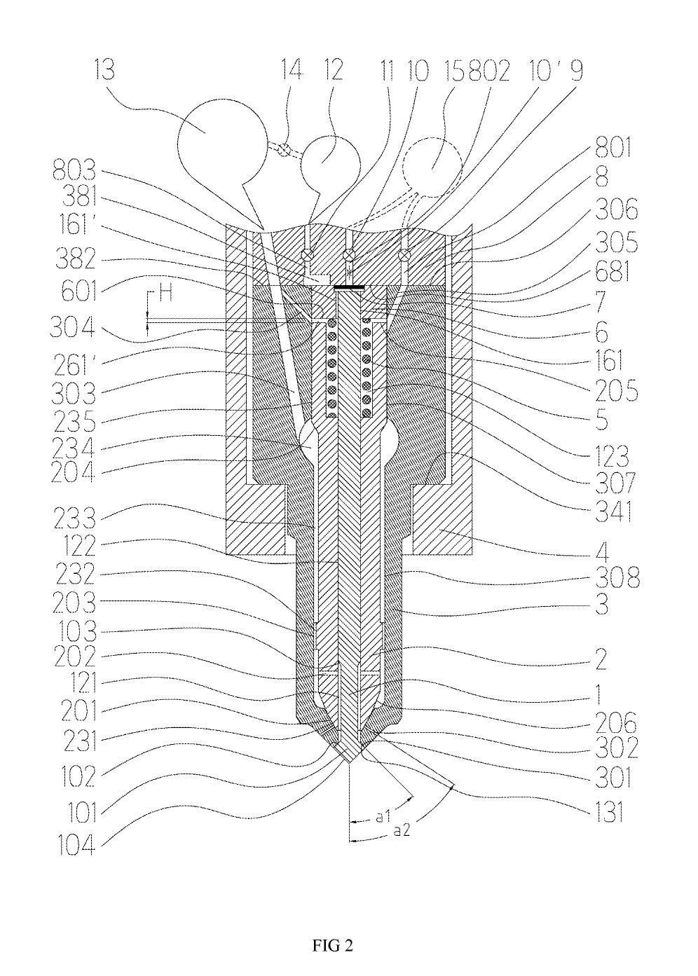

A first embodiment was shown in FIG. 1 to FIG. 4. FIGS. 1 & 2 show the State I when both the outward opening valve 1 and inward opening valve 2 is at seating position. At State I, the combined pressure force from pressure control chamber 261′ and the elastic force from spring 5 are urging both needle valve 1 and 2 into seating position. While at State I, valve 11 is closed, valve 10 is open, valve 9 is closed.

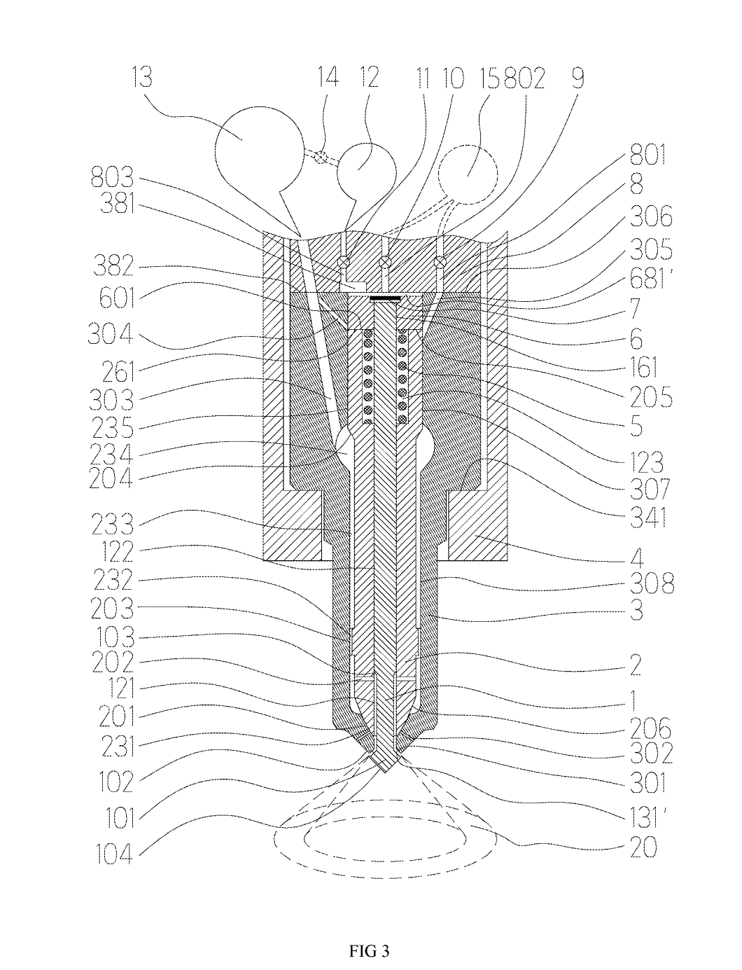

FIG. 3 shows the State II when the outward opening needle valve 1 is open, and fuel is injected into combustion chamber in a hollow conical spray pattern (20). When control valve 11 is open, high pressure fuel from 12 will fill the pressure control chamber of 681′. Since the pressured top surface of guide 6 is larger the pressured bottom surface of guide 6, when the control valve 9 is also opened, it will ensure the downward force applied to 6 will conquer the force from spring 5 and upward force from bottom of 6. The needle valve 1 will be forced to move outward and form an annular injection outlet 131′, fuel will be guided to nozzle tip through passage from 303 to 233 to 232, and continue to 202 to 121, and injected into combustion chamber in a hollow conical spray pattern through annular outlet 131′. At the same time, due to the fast transient process and small distance between guide 6 and top of needle 1, the pressure in 261′ is still high enough to conquer the forces lifting needle valve 2, therefore needle valve 2 remains seated. By the time of ending injection, control valve 11 is closed, valve 10 is open, control valve 9 is closed, the pressure will be raised in chamber 261′, needle guide 6 will be pushed back to top position, the needle valve 1 will be returned to seating position. At the same time, the control valve 9 will be closed. The pressure will built up in pressure control camber 261′ and urge both needle valve 1 and 2 in seating position, fuel injection ends, and the fuel injector return to State I.

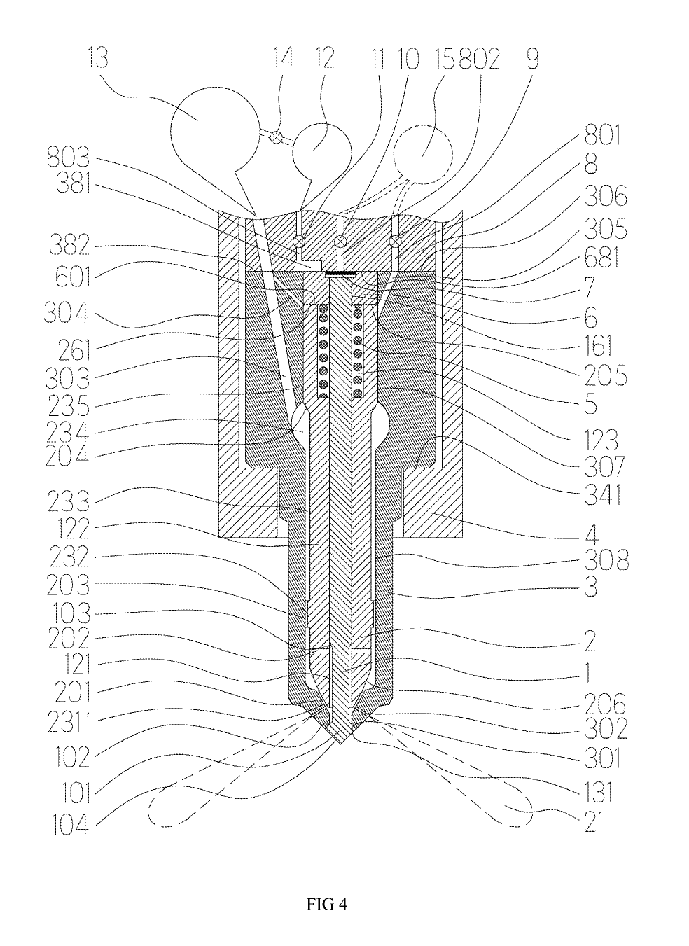

FIG. 4 shows the State III when the inward opening needle valve 2 is open, and fuel is injected into combustion chamber in conventional multiple jet spray patterns (21). When control valve 9 is open from State I and valve 11 and 10 keeps the same states as State I, small amount of high pressure fuel will flow out from control chamber 261′ to low pressure fuel sink 15, the pressure in control chamber 261′ is reduced such that the thrusting force from the thrusting surface of needle valve 2 will conquer the downward forces from spring 5, the needle valve 2 will be lifted from its seating position, the high pressure fuel will pass through passage 303 to 233 and 232 and flow in two passes including one pass (231′) under the needle seat of 2 and one passes through 202 to 121, together supply fuel to fuel outlet 302 to inject fuel into combustion chamber. Once control valve 9 is closed, the pressure in control chamber 261′ will rise again, and the pressure force on top of needle valve 2 will conquer the thrusting forces on needle valve 2, with addition of pressing force from spring 5, the needle valve 2 will be forced into seating position, fuel injection ends, and the injector return to closing position as stated in State I.

The invention fuel injector can also reach another state—State IV (not shown here), where both the inward opening valve and outward opening valve is open, the fuel is injected in both multiple jet spray patterns and hollow conical spray patterns. Even though this state is rarely used, but it is doable. To reach State IV from State I, we first open control valve 9, this will activate the inward needle valve to inject fuel in multiple jet format, than we open control valve 11 to open needle valve 1, by adjusting the time delay between turning on valve 11 and 9, the forces from pressure chamber 681′ and 261′ and spring 5 will reach a transient balance, the fuel will also be injected from outlet 131′ in hollow conical spray pattern. When we close the control valve 11, the outward opening valve 1 will return to seating position, when the control valve 9 is closed, the inward opening valve 2 will be forced into seating position, all fuel injection ends. The fuel injector returns to State I.

We have illustrated one embodiment here. For those skilled in the art, it is easy to give alternatives based on the same operation mechanism. The embodiment illustrated here should be considered as an example without limiting the scope of the invention. Other embodiments with the same key characteristics and spirit are considered under the scope of this invention. For example, one can add a throttling valve (10′) under control valves (9, 10). One can also add a spring under throttling valve (10′) and above needle guide (6) in the fuel passage (802) to damp the force of the needle guide (6). As an alternative for needle clip (7), one can use screw (161′) to tight needle valve guide (6) into the outward opening needle valve (1). Further, we may apply adiabatic material coating such as ceramics on top surface of needle head (104) of needle valve 1. Following features are considered as the key characteristics of the invention.

Statement A: A variable orifice fuel injector comprising:

a nozzle body (3) comprising passages for pressured fuel, an inner cylindrical space for receiving two longitudinally displaceable coaxial needle valves (1,2) with an inner needle valve (1) which is outward opening and which is moving away relative to said nozzle body (3) large end (306) to reach opening position, and an outer needle valve (2) which is inward opening and which is moving toward nozzle body large end to reach opening position, and a needle valve guide (6) tightly guide said inner needle valve (1) along cylindrical space of said nozzle body (3), small cylindrical fuel outlets (302) in said nozzle body (3) and one annular fuel outlet formed by the gap between said nozzle body (3) and said outward opening needle valve (1) when it is opened, and two seal surfaces on said nozzle body (3) with a conical surface (231) which provides sealing for said inward opening valve (2) to block fuel, and another conical surface (131) which provides the sealing for the outward opening valve (1) and guides the fuel path, a spring (5) partially contained in said needle valve (2) urging both said two coaxial needle valves (1,2) into biased seating positions to block fuel, a holding cap (4) to hold parts, and a valve block (8) to hold control valves, and said outward opening needle valve (1) has means to inject fuel into combustion chamber in a hollow conical spray pattern through annular fuel outlet (131′) when it is displaced from seating position by driving forces; and said inward opening needle valve (2) has means to inject fuel into combustion chamber in conventional multiple jet patterns through fuel outlets (302) when said needle valve (2) is lifted; Where in, said outward opening needle valve (1) and inward opening needle valve (2) has means to inject fuel in different hollow conical spray patterns and conventional multiple jet spray patterns selectively and independently.

Statement B: A fuel injector according to above Statement A, where in it is comprising at least two control valves (9, 10, 11) to control the fuel flow from high pressure fuel reservoirs (13) and flow to low pressure fuel sink (15) to produce the lifting and closing forces on said needle valves (1, 2) through generating pressure differences in pressure control chambers (381, 681′, 261′, 234), where in two of the control valves (10, 11) have opposite opening-closing status and can be served with a single solenoid or piezoelectric actuator to control the lifting of said outward opening needle valve (1), and another valve (9) is served with a separate actuator to control the lifting and closing of said inward opening valve (2), where in said two valves (1,2) have the same maximum lift (H).

Statement C: A fuel injector of according to Statement A, where in said outward opening needle valve (1) is longitudinally displaceable and partially within said inward opening needle valve (2) and guided by said needle guide (6) which is longitudinally displaceable in the inner bore of said nozzle body (3), and said needle valve (1) has a converging-diverging-converging arrow-head shape needle head for guiding a hollow conical spray of fuel, wherein said needle valve (1) is at a biased closing position with its seal surface (102) being pressed against nozzle body (3) by spring (5) and pressure force on needle guide bottom surface (601) to block fuel flow, or at an opening position through pushing the top surface of needle guide (6) with pressured fuel to force said needle valve moving outward, and inject fuel in a hollow conical spray pattern through annular fuel outlet (131′) between said arrow-head shape needle head and said nozzle body tip surface (301) to inject fuel in a hollow conical spray pattern.

Statement D: A fuel injector of according to above Statement A, where in said inward opening needle valve (2) has a cylindrical space to partially hold spring (5) and said outward opening needle valve (1), where in said needle valve (2) is further comprising a needle guide (203) and fuel passages (232, 202), and a top end (205) to define the maximum needle lift together with needle guide (6), and thrusting surfaces (204, 206) to generating lifting force to lift the needle to inject fuel in conventional multiple jet spray pattern through fuel outlets (302);

Statement E: A fuel injector of according to above Statement A, where in the half fuel spray angle for hollow conical spray (a1) and half spray angle for multiple jet (a2) can be same or different, where in with preferred embodiment such that a1 is smaller than a2.

Statement F: A fuel injector according to any Statements A to E above, wherein the needle lift for the opening position is approximately in the range of 0-300 μm, the needle head diameter of said outward opening needle valve (1) is approximately in the range of 0.8-3.5 mm, and the half conical spray angle (a1) is approximately in the range of 15-60 degree, and the half multiple jet spray angle (a2) is approximately in the range of 60-75 degree;

Statement G: A fuel injector according to any of the above Statements A to F, where in the guiding surface of the inward opening needle valve (2) and the guiding surface of needle guide (6) for said outward opening valve (1) shares a same section of cylindrical inner surface of said nozzle body (3) where in has means to ensure the coaxial movement of said inward and outward opening needle valves (1, 2) along the center axial line of said nozzle body (3).

Statement H: A fuel injector according to any of above Statements A to G, wherein said outward opening needle valve (1) is directly driven by an actuator.

Statement I: A fuel injector according to any of above Statements A to H, wherein the actuators for control valves (11, 9) are a solenoid or a piezoelectric actuator.

Statement J: An internal combustion engine using a fuel injector of any of above Statements A to I, which can be a spark-ignition engine or a compression-ignition engine, where in it has means to inject fuel with different spray patterns at different injection timings, preferably with at least one fuel injection tends to hollow conical spray patterns for earlier injections which is away from engine top dead center (TDC), and at least one main fuel injection tends to conventional multiple jet around TDC, and one optional late injection which is away from TDC.

1. A variable orifice fuel injector comprising:
(i) a nozzle body (3) comprising passages for pressured fuel, an inner cylindrical space for receiving two longitudinally displaceable coaxial needle valves (1,2) with an outward opening inner needle valve (1) which is moving away relative to nozzle body large end (306) to reach opening position, and an inward opening outer needle valve (2) which is moving toward nozzle body large end to reach opening position, and a needle valve guide (6) which guides said outward opening needle valve (1) along cylindrical space of said nozzle body, fuel outlets (302) in said nozzle body, and two seal surfaces on said nozzle body with a seal surface (231) which provides sealing for said inward opening needle valve (2) to block fuel, and another seal surface (131) which provides the sealing for said outward opening needle valve (1) and guidance for fuel path, a spring (5) which urges both said two coaxial needle valves (1,2) into biased seating positions to block fuel, a holding cap (4) to hold parts, and a valve block (8) to hold control valves, and
(ii) said outward opening needle valve (1) which has means to inject fuel into combustion chamber in a hollow conical spray pattern through annular fuel outlet (131′) when it is displaced from seating position to opening positions by driving forces, and
(iii) said inward opening needle valve (2) which has means to inject fuel into combustion chamber in conventional multiple jet spray patterns through fuel outlets (302) when it is lifted from seating position to opening positions;
Where in, said variable orifice fuel injector has means to inject fuel in different hollow conical spray patterns and conventional multiple jet spray patterns selectively and independently.

2. A fuel injector of claim 1, where in it is comprising at least two valves (9, 10, 11) to control the fuel flow from high pressure fuel reservoirs (12, 13) and fuel flow to low pressure fuel sink (15) to produce the lifting and closing forces on said needle valves (1,2) through generating pressure differences in pressure control chambers (381, 681′, 261′, 234), where in two of the control valves (10,11) have opposite opening-closing states and can be served with a single actuator to control the longitudinal displacement and closing of said outward opening needle valve (1), and another control valve (9) is served with a separate actuator to control the lifting and closing movement of said inward opening needle valve (2), where in said inward and outward opening needle valves (1,2) have the same maximum needle lift (H).

3. A fuel injector of claim 1, where in said outward opening needle valve (1) is longitudinally displaceable and partially contained within said inward opening needle valve (2) and guided by said needle guide (6) which is longitudinally displaceable in the inner bore of said nozzle body (3), and said outward opening needle valve (1) has an arrow-head shape needle head for guiding a hollow conical spray of fuel, wherein said needle valve (1) is at a biased closing position with its seal surface (102) being pressed against nozzle body (3) by spring (5) and pressure force on needle guide bottom surface (601) to block fuel flow, or at an opening position through pushing the top surface of needle guide (6) with pressured fuel to force said needle valve (1) moving outward, therefore form an annular outlet (131′) between said arrow-head shape needle head and said nozzle body tip surface (301) to inject fuel in a hollow conical spray pattern.

4. A fuel injector of claim 1, wherein said inward opening needle valve (2) has a cylindrical space to partially hold spring (5) and said outward opening needle valve (1), where in said inward opening needle valve (2) is further comprising a needle guide (203) and fuel passages (202, 232), and a top end (205) to define the needle lift together with needle guide (6), and thrusting surfaces (204, 206) to generating lifting force to lift the needle to inject fuel in conventional multiple jet spray pattern through fuel outlets (302);

5. A fuel injector of claim 1, where in the half fuel spray angle for hollow conical spray (a1) and half spray angle for multiple jet (a2) can be same or different, where in with preferred embodiment such that a1 is smaller than a2.

6. A fuel injector according to any claims 1 to 5 above, wherein the maximum needle lift (H) for both outward and inward opening valves (1,2) is approximately in the range of 0-300 μm, the needle head diameter of said outward opening needle valve (1) is approximately in the range of 0.8-3.5 mm, and the half conical spray angle (a1) is approximately in the range of 15-60 degree, and the half multiple jet spray angle (a2) is approximately in the range of 60-75 degree;

7. A fuel injector according to any of the claims 1 to 6 above, where in the guiding surface of the inward opening outer needle valve (2) and the guiding surface of needle guide (6) for said outward opening inner valve (1) shares a same section of cylindrical inner surface of said nozzle body (3) wherein it has means to ensure the coaxial movement of said inward and outward opening needle valves (1, 2) along the center axial line of said nozzle body (3).

8. A fuel injector according to any claim of 1 to 7, wherein said outward opening needle valve (1) is directly driven by an actuator.

9. A fuel injector according to any claim of 1 to 8, wherein the actuators for control valves (11, 9) are a solenoid or a piezoelectric actuator.

10. An internal combustion engine using a fuel injector of any claim above, which can be a spark-ignition engine or a compression-ignition engine, where in it has means to inject fuel with different spray patterns at different injection timings, preferably with at least one fuel injection tends to hollow conical spray patterns for early injections which is away from engine piston top dead center (TDC), and at least one main fuel injection tends to conventional multiple jets around TDC, and one optional late injection tends to hollow conical spray patterns which is away from TDC.
